(19) United States
(12) Patent Application Publication
(10) Pub. No.: US 2014/0325146 A1
(43) Pub. Date: Oct. 30, 2014

(54) CREATING AND MANAGING LOGICAL VOLUMES FROM UNUSED SPACE IN RAID DISK GROUPS

(71) Applicant: LSI CORPORATION, San Jose, CA (US)

(72) Inventors: Naresh Madhusudana, Bangalore (IN); Naveen Krishnamurthy, Bangalore (IN)

(73) Assignee: LSI CORPORATION, San Jose, CA (US)

(21) Appl. No.: 13/971,307

(22) Filed: Aug. 20, 2013

(30) Foreign Application Priority Data
Apr. 29, 2013 (IN) 1913CHE2013

(51) Int. Cl. G06F 3/06

(52) U.S. Cl. CPC G06F 3/0689; G06F 3/0614; G06F 3/0646
USPC 711/114

(57) ABSTRACT

Methods and structure are provided for creating and managing unused storage capacity in Redundant Array of Independent Disks (RAID) systems. One embodiment is a RAID controller that includes a controller operable to create and manage a logical volume out of storage space that would otherwise not be used by a RAID system. The logical volume is then exposed to the host operating system as a logical volume where the storage space can be used as a cache device for a host operating system.

### CROSS REFERENCE TO RELATED APPLICATIONS

This document claims priority to Indian Patent Application Number 1913/CHE/2013 filed on Apr. 19, 2013 (entitled PREEMPTIVE CONNECTION SWITCHING FOR SERIAL ATTACHED SMALL COMPUTER SYSTEM INTERFACE SYSTEMS) which is hereby incorporated by reference

### FIELD OF THE INVENTION

The invention relates generally to Redundant Array of Independent Disks (RAID) systems, and more specifically to efficient use of storage capacity in storage devices.

### BACKGROUND

In existing RAID storage systems, multiple storage devices can be used to implement a logical volume of data. When the data for the logical volume is kept on multiple storage devices, the data can be accessed more quickly because the throughput of the storage devices can be combined. Furthermore, when the data is stored on multiple storage devices, redundancy information can be maintained so that the data will be preserved even if a storage device fails. However, when multiple storage devices are used to implement a logical RAID volume, data is spread evenly across the multiple storage devices. As a result, each storage device in a group RAID configuration is limited to allocating only the amount of storage capacity of the smallest individual storage device that is in the group. A storage device that has more storage capacity than the smallest storage device will be unable to allocate or otherwise use its excess storage capacity.

### SUMMARY

Systems and methods herein provide RAID systems that allow for a single logical volume to be implemented out of the uneven storage capacities located on one or more storage devices in a group. One embodiment includes a RAID controller operable to create and manage a logical drive out of storage space that would otherwise not be used by a RAID system. The logical drive is then exposed to the host operating system as a logical volume where the storage space can be used as a cache device or other form of storage for a host operating system.

In one embodiment, the system identifies a capacity representing the highest common storage capacity among individual storage devices belonging to a group of storage devices. The individual storage devices have varying levels of individual storage capacity. The system allocates space in each of the individual storage devices in the amount of the highest common storage capacity as a Redundant Array of Independent Disks volume and generates a single logical volume out of the unallocated space located in one or more of the individual storage devices.

Other exemplary embodiments (e.g., methods and computer readable media relating to the foregoing embodiments) are also described below.

### BRIEF DESCRIPTION OF THE FIGURES

Some embodiments of the present invention are now described, by way of example only, and with reference to the accompanying figures. The same reference number represents the same element or the same type of element on all figures.

FIG. 1 is a block diagram of an exemplary Redundant Array of Independent Disks (RAID) storage system.

FIG. 2 is a block diagram of an exemplary storage device configuration of a RAID storage system.

FIG. 3 is a flowchart describing an exemplary method of creating a logical drive out of unallocated storage space in the RAID storage system of FIG. 1.

FIG. 4 is a flow chart describing an exemplary method for creating a lookup table for mapping the logical drive to the storage devices and handling an Input/Output (I/O) request.

FIG. 5 illustrates an exemplary processing system operable to execute programmed instructions embodied on a computer readable medium.

### DETAILED DESCRIPTION OF THE FIGURES

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

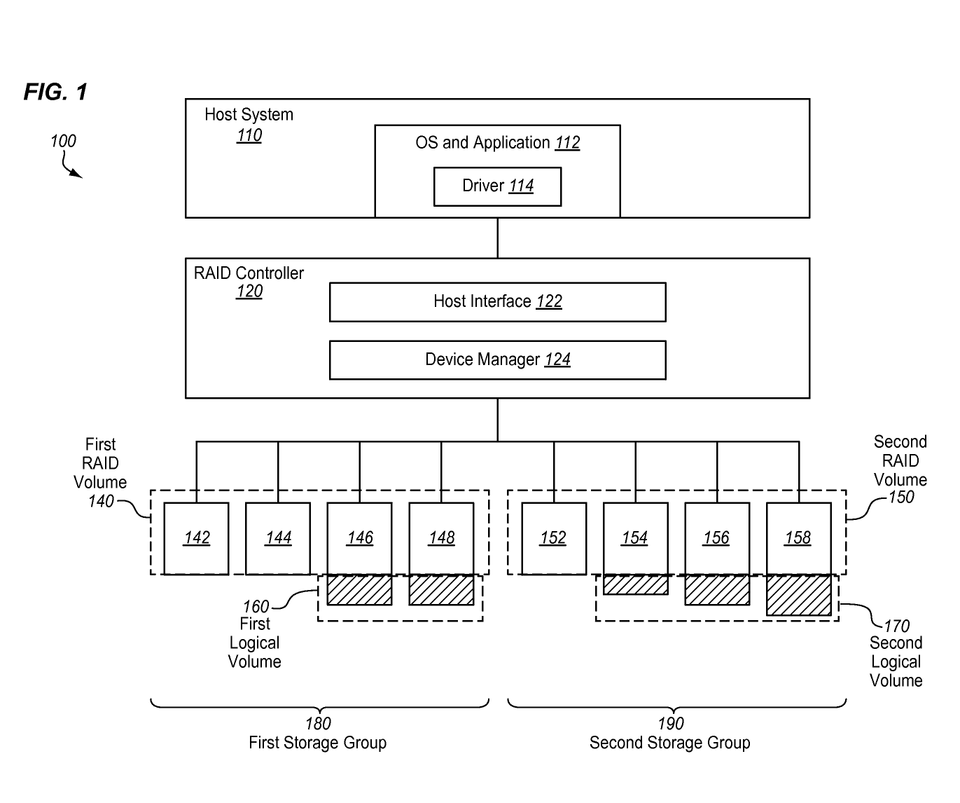

FIG. 1 is a block diagram of an exemplary Redundant Array of Independent Disks (RAID) storage system 100. Host System 110 and RAID controller 120 are configured to maximize the use of storage capacity in a storage system that uses disk drives with different storage capacities. For a given group of storage devices, a logical volume is created from the excess capacity resulting from the creation of a RAID volume.

As shown in FIG. 1, storage devices 142-148 belong to first storage group 180, while storage devices 152-158 belong to second storage group 190. The capacity of storage devices 142-148 and 152-158 may differ from one another. For instance, in first storage group 180, storage devices 146 and 148 have a larger available capacity than storage devices 142 and 144. The excess capacity on the storage devices is shown in shaded grey. In the second storage group 190, storage device 152 has the smallest storage capacity and each of the storage devices 154, 156, and 158 thereafter increase in storage capacity. This excess capacity of the two groups 180 and 190 previously went unused.

Although FIG. 1 illustrates eight storage devices 142, 144, 146, 148, 152, 154, 156, and 158, the present invention is not limited to a particular number of storage devices or storage groups, but rather may be adapted to accommodate any number of storage devices, storage groups and/or RAID volumes. RAID storage system 100 may implement any RAID level, such as RAID level 0, 2, 3, 5, 6, etc. The storage devices may comprise magnetic hard disks, solid state drives, optical media, etc. compliant with protocols for SAS, Serial Advanced Technology Attachment (SATA), Fibre Channel, etc.

Host system 110 may be any computer system capable of communicating over a network and which may include one or more processors operable to run computer programs thereon. In some implementations, host system 110 includes RAID controller 120. Host system 110 includes computer-executable code such as an OS/Application 112 that provides access to files located on a drive, such as storage devices 142-148 and 152-158. OS/Application 112 may load a driver 114 that virtualizes physical storage devices. In some implementations, OS/Application 112 loads a driver 114 that communicates with storage devices configured as one or more logical volumes. Driver 114 may be configured to create a logical volume or recognize a controller that combines two or more storage devices into a logical volume.

RAID controller 120 includes host interface 122 and device manager 124. Host interface 122 interfaces RAID controller 120 with host system 110. In one embodiment, RAID controller 120 is a standalone controller and is coupled to the host system 110 via a local bus, such as a Peripheral Component Interconnect (PCI), PCI-X, PCI-Express, or other PCI family local bus.

In one embodiment, RAID controller 120 is a Host Bus Adapter (HBA) tightly coupled with a corresponding driver 114 in the host system 110. RAID controller 120 provides Application Programming Interfaces (APIs) that enables a mapping structure within the RAID controller 120 to map an Input/Output (I/O) request from host system 110 to corresponding physical storage locations on the one or more storage devices 142-148 and 152-158 that comprise the logical volume. In this way, RAID controller 120 manages the mapping processes and the redundancy computations for the RAID volumes.

In another embodiment, the RAID controller 120 provides an optional bypass mechanism so that a driver 114 on the host system 110 performs the mapping of the physical storage locations to the logical volume. Such a bypass mechanism is referred to as a “fast path” or “pass-through” interface. The fast path driver 114 on the host system 110 sends I/O requests directly to the relevant physical locations of storage devices 142-148 and 152-158 coupled with the RAID controller 120. The RAID controller 120 with a fast pass option provides the driver 114 with mapping information so that the RAID controller 120 need not perform the mapping and RAID redundancy computations.

Device manager 124 is capable of assigning coupled storage devices to one or more logical volumes. Device manager 124 exposes each of the storage devices 142-148 and 152-158 to the host system 110 as one or more logical volumes. In this way, first logical volume 160 and/or second logical volume 170 appear to host system 110 as a continuous set of Logical Block Addresses (LBAs).

While RAID controller 120 is illustrated in FIG. 1 as being directly coupled with multiple storage devices, in some embodiments RAID controller 120 may be coupled with various storage devices via a switched fabric. A switched fabric comprises any suitable combination of communication channels operable to forward/route communications for a storage system, for example, according to protocols for one or more of Small Computer System Interface (SCSI), Serial Attached SCSI (SAS), FibreChannel, Ethernet, Internet SCSI (ISCSI), etc. In one embodiment, a switched fabric comprises a combination of SAS expanders that link to one or more target storage devices.

The particular arrangement, number, and configuration of components described herein is exemplary and non-limiting.

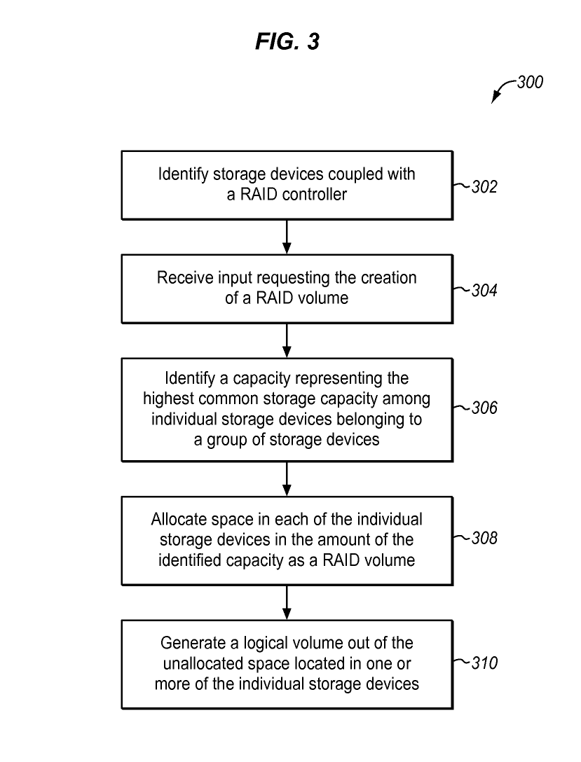

FIG. 3 is a flowchart 300 describing an exemplary method to create and manage logical volumes for the RAID storage system 100. Assume, for the purposes of FIG. 3 below, that RAID controller 120 initializes a discovery process (e.g., when RAID storage system 100 is first implemented) in order to identify which storage devices it is coupled with.

In step 302, RAID controller 120 identifies coupled storage devices 142-148 and 152-158. In one embodiment, this includes e.g., actively querying the device name and capacity of each storage device identified during a discovery process, and storing that information in memory at RAID controller 120 for later reference. The device address (e.g., SAS address), capacity of each storage device, and group that the device belongs to may be programmed into a memory of RAID controller 120 through the device manager 124.

In step 304, RAID controller 120 receives input requesting the creation of a RAID volume. In one embodiment, this input is provided by host 110, and the input indicates a size for the logical volume, an identifier for the logical volume, and further indicates a requested RAID level for the logical volume (e.g., RAID 0, 1, 5, etc.). The input may also indicate the grouping configuration of the storage devices.

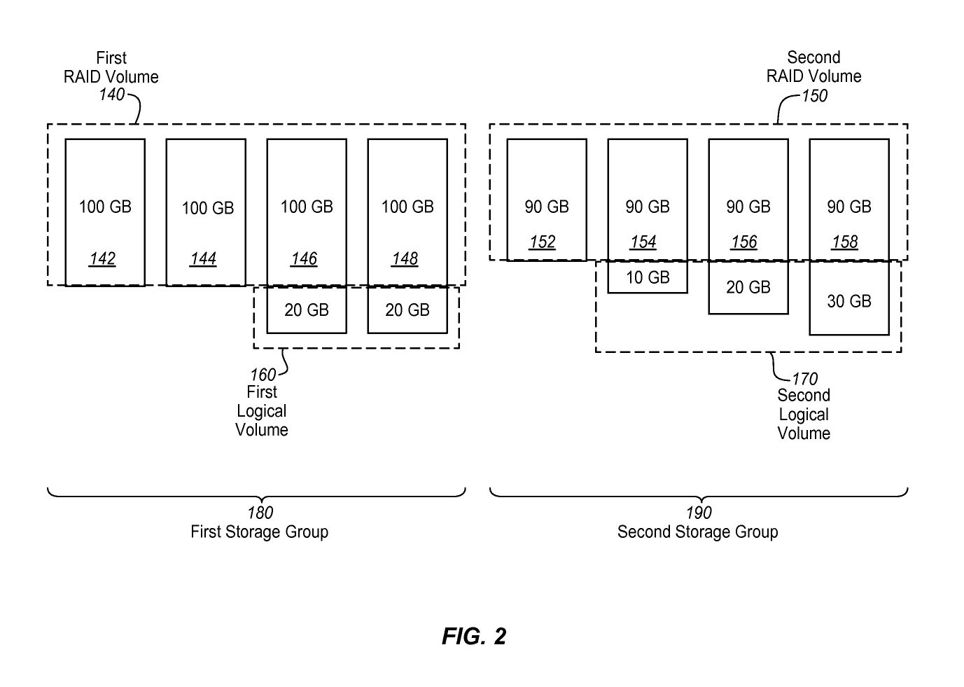

In step 306, RAID controller 120 identifies a capacity representing the highest common storage capacity among individual storage devices belonging to a group of storage devices. In one embodiment, RAID controller 120 discovers the highest common capacity by accessing the information stored at step 302. By way of example, reference is made to FIG. 2, which is an exemplary embodiment of storage devices 142-148 and 152-158 of RAID storage system 100. As shown in FIG. 2, storage devices 142, 144, 146, and 148 belong to the first storage group 180 and storage devices 152, 154, 156, and 158 belong to the second storage group 190. The portion of capacity on each storage disk that exceeds the capacity of the smallest disk in the RAID system is typically completely unused by the operating system.

In FIG. 3, first storage group 180 has four storage devices 142, 144, 146, and 148. Storage device 142 has 100 gigabytes (GB) of capacity, storage device 144 has 100 GB of capacity, storage device 146 has 120 GB of capacity, and storage device 148 has 120 GB of capacity. Thus, the smallest storage device in the first storage group 180 is 100 GB and the RAID controller identifies 100 GB as the highest common storage capacity among the individual storage devices belonging to the first storage group 180.

Similarly, second storage group 190 has four storage devices 152, 154, 156, and 158. Storage device 152 has 90 GB of capacity, storage device 154 has 100 GB of capacity, storage device 156 has 110 GB of capacity, and storage device 158 has 120 GB of capacity. Thus, the smallest storage device in the second storage group 190 is 90 GB and the RAID controller identifies 90 GB as the highest common storage capacity among the individual storage devices belonging to the second storage group 190.

At step 308, the RAID controller 120 allocates space in each of the individual storage devices in the amount of the identified capacity as a RAID volume. Continuing with the example in FIG. 2, the RAID controller allocates 100 GB of space in storage devices 142, 144, 146, and 148 to create a first RAID volume 140 with a total of 400 GB of allocated space to be used in RAID configuration. The RAID controller 120 also allocates 90 GB of space in storage devices 152, 154, 156, and 158 to create a second RAID volume 150 with a total of 360 GB of allocated space to be used in RAID configuration.

For example, as shown in FIG. 2, storage device 146 and 148 each have a total capacity of 120 GB. Thus, storage device 146 and 148 each have 20 GB of unallocated space. The unallocated 20 GB in each of storage device space is then used to create a single logical volume. For the first group of storage devices 142-148, RAID controller 120 would generate a single 40 GB logical volume from storage devices 146 and 148.

In the second group, second RAID volume 150 is implemented using 90 GB on each of storage device 152, 154, 156, and 158 for a total of 360 GB of allocated space for the RAID. However, storage device 154 has a total capacity of 100 GB and thus has 10 GB unallocated. Similarly, storage device 156 has 20 GB of unallocated space and storage device 158 has 30 GB of unallocated space since they have total capacities of 110 GB and 120 GB, respectively. Thus, RAID controller 120 generates a single 60 GB logical volume from the unallocated space on storage devices 154, 156, and 158.

Even though the steps of method 300 are described with reference to RAID storage system 100 of FIG. 1, method 300 may be performed in other RAID systems. The steps of the flowcharts described herein are not all inclusive and may include other steps not shown. The steps described herein may also be performed in an alternative order.

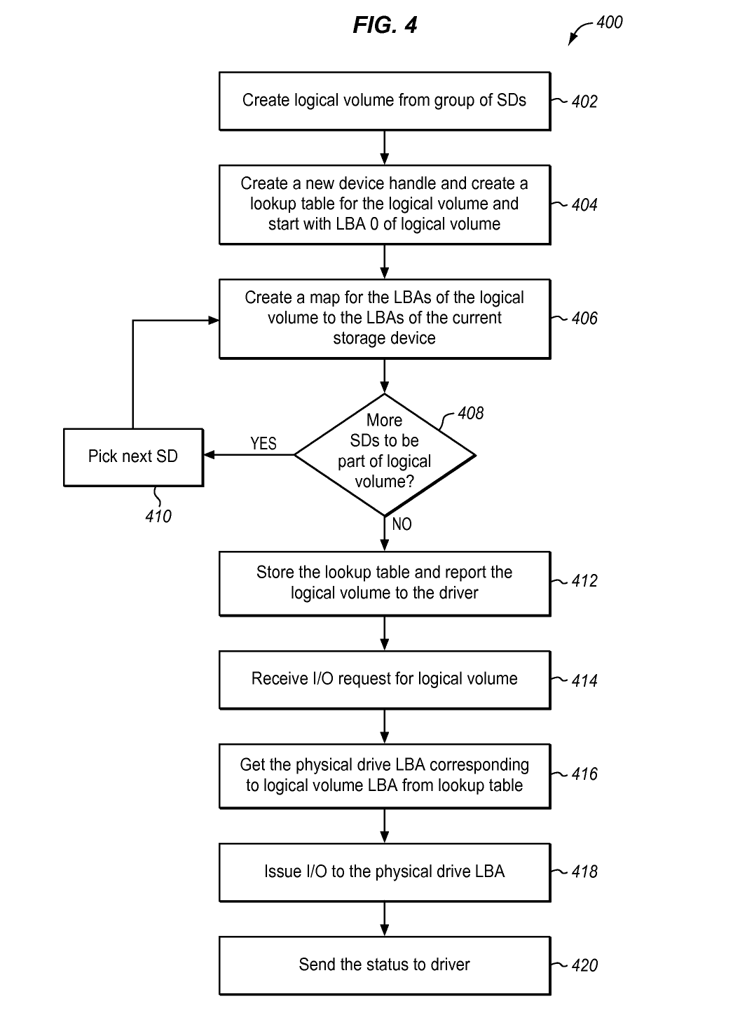

At step 310, the RAID controller 120 generates a logical volume out of the unallocated space located in one or more of the individual storage devices. The unallocated space may be identified prior to or in the absence of a RAID volume being created from the storage devices. In one embodiment, the RAID controller 120 locates unallocated space spread across multiple storage devices in a group and creates only one logical volume for the total amount of unallocated space in the group. In another embodiment, the RAID controller 120 locates unallocated space spread across multiple storage devices in a group and partitions the total amount of unallocated space into two or more logical volumes. Further description on the generation of a logical drive from unallocated space can be found in the discussion of FIG. 4 below.

FIG. 4 is a flow chart describing an exemplary method for creating a logical volume out of unused space, mapping the logical volume to one or more storage devices and handling an I/O request.

At step 402, a logical volume is created from a given set of storage devices (e.g., 142-148 and 152-158) as described in FIG. 3. The logical volume may be created in response to a user or application request. Alternatively, the logical volume may be automatically created after a group of storage devices have been configured for RAID and/or when it is determined that uneven storage capacities exist in a given group of storage devices.

At step 404, a new device handle and a lookup table are created for the logical volume. The new device handle may be created as part of the device manager 124 or as separate firmware that runs on the RAID controller 120. The RAID controller 120 represents the logical volume to host system 110 as a continuous set of Logical Block Addresses (LBAs), starting with LBA 0 of the logical volume.

Next, at step 406, a map is created for the LBAs of the logical drive to the LBAs of a first storage device. The RAID controller 120 stores this mapping data in memory (e.g., at RAID controller 120 and/or on the storage devices themselves) in order to enable translation between logical addresses requested by host system 110 and physical addresses on the storage devices 142-148 and 152-158.

Once The RAID controller 120 has mapped the last available physical address on the first storage device, the RAID controller 120 next determines at step 408 if more storage devices are to be a part of the logical volume. That is, the RAID controller 120 determines if there is a second storage device in the group that has storage capacity in excess of the highest identified common storage capacity of the group. RAID controller 120 may have previously identified the storage devices that are coupled to the RAID controller 120 and which storage devices contain excess storage capacity compared to the lowest individual storage device capacity in a group of storage devices. This previously identified information may be stored in a memory cache accessible to RAID controller 120.

If the RAID controller 120 determines at step 408 that there is another storage device in the group that has excess storage capacity, then a map is created for the LBAs of the logical volume to the LBAs of a next storage device. If, at step 408, there are no other storage devices that have excess storage capacity then the RAID controller 120 proceeds to step 412 and stores the lookup table in memory and reports the newly created logical volume to the operating system 112. In one embodiment, the RAID controller 120 creates new device handles and lookup tables for logical drives and then reports one or more logical drives as a logical volume to the operating system 112.

At steps 414, 416, and 418, the RAID controller receives I/O requests for the logical volume, retrieves the physical drive LBA corresponding to the logical volume LBA from lookup table, and issues the I/O command to the physical drive LBA. In this way, the RAID controller 120 correlates each requested LBA with a physical location on a storage device. At step 420, the driver 114 is updated with the status of the I/O request.

As noted above, fast path or pass-through I/O requests may be generated by a driver 114 of the host system 110. This enables the host system 110 to communicate directly with the storage devices 142-148 and 152-158. Firmware on the RAID controller 120 provides the logical to physical drive translation table to the host system 110 during the discovery as part of device properties. The driver 114 can use this information to generate appropriate physical drive requests and use features like fast path or pass-through where RAID controller 120 does not have any role.

In one embodiment, a logical volume is reported by firmware on the RAID controller 120 to the host system 110 during initial discovery. The lookup table is retrieved/requested from the RAID controller 120 firmware and stored locally on the host system 110. When an I/O is received for a logical volume, the locally stored lookup table is used to get the physical storage device and LBA corresponding to the request. The I/O may then be performed using fast path or pass-through to complete the I/O request.

The OS or application 112 on the host system 110 may use the storage devices with excess capacity (i.e., capacity not allocated for a RAID) to store data in the volume. Some data does not need to be protected by RAID or is data of temporary nature. In order for the OS/application 112 to make use of the RAID volume region more efficiently, only data which is determined to need RAID protection is stored in the RAID volume. Data which doesn't need RAID protection can be stored in the logical volume created with the storage devices with uneven excess storage capacity. With existing methods, temporary data is stored in the RAID volume which takes more time to write to a RAID volume due to time consumption for parity calculation, striping, or mirroring. However, in the present embodiment, the uneven space of the storage devices are exposed to the OS or application 112 which can then use the space as a physical drive without RAID protection or as a cache device for the operating system (OS) or Application 112. In this way, the RAID system makes efficient use out of storage capacity in the system that would otherwise go unused.

In one embodiment, OS 112 uses the logical drive as a swap region used to swap active and passive processes. For example, currently executing processes stored in RAM, inactive processes stored in a storage device or temporary data of an application which does not need protection could all be stored in the logical drive. In one embodiment, the logical drive is used as swap space for the operating system 112 to store data for inactive processes.

Even though the steps of method 400 are described with reference to RAID storage system 100 of FIG. 1, method 400 may be performed in other RAID systems. The steps of the flowcharts described herein are not all inclusive and may include other steps not shown. The steps described herein may also be performed in an alternative order.

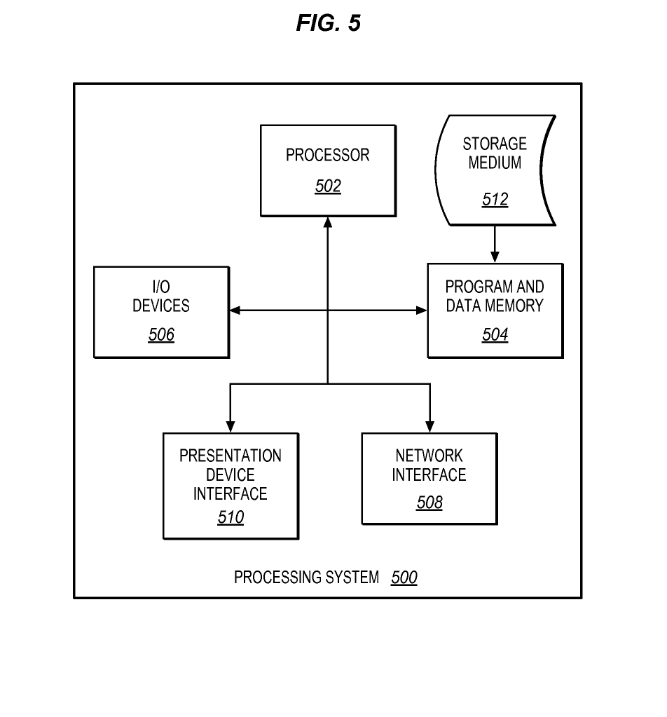

Embodiments disclosed herein can take the form of software, hardware, firmware, or various combinations thereof. In one particular embodiment, software is used to direct a processing system of RAID controller 120 to perform the various operations disclosed herein. FIG. 5 illustrates an exemplary processing system 500 operable to execute a computer readable medium embodying programmed instructions. Processing system 500 is operable to perform the above operations by executing programmed instructions tangibly embodied on computer readable storage medium 512. In this regard, embodiments of the invention can take the form of a computer program accessible via computer readable medium 512 providing program code for use by a computer (e.g., processing system 500) or any other instruction execution system. For the purposes of this description, computer readable storage medium 512 can be anything that can contain or store the program for use by the computer (e.g., processing system 500).

Computer readable storage medium 512 can be an electronic, magnetic, optical, electromagnetic, infrared, or semiconductor device. Examples of computer readable storage medium 512 include a solid state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

Processing system 500, being suitable for storing and/or executing the program code, includes at least one processor 502 coupled to program and data memory 504 through a system bus. Program and data memory 504 can include local memory employed during actual execution of the program code, bulk storage, and cache memories that provide temporary storage of at least some program code and/or data in order to reduce the number of times the code and/or data are retrieved from bulk storage during execution.

I/O devices 506 (including but not limited to keyboards, displays, pointing devices, etc.) can be coupled either directly or through intervening I/O controllers. Network adapter interfaces 508 may also be integrated with the system to enable processing system 500 to become coupled to other data processing systems or storage devices through intervening private or public networks. Modems, cable modems, IBM Channel attachments, SCSI, Fibre Channel, and Ethernet cards are just a few of the currently available types of network or host interface adapters. Presentation device interface 510 may be integrated with the system to interface to one or more presentation devices, such as printing systems and displays for presentation of presentation data generated by processor 502.

What is claimed is:

1. A Redundant Array of Independent Disks controller, comprising:
a device manager operable to:
identify a capacity representing the highest common storage capacity among individual storage devices belonging to a group of storage devices, wherein the individual storage devices have varying levels of individual storage capacity;
allocate space in each of the individual storage devices in the amount of the highest common storage capacity as a Redundant Array of Independent Disks volume; and
generate a single logical volume out of the unallocated space located in one or more of the individual storage devices.

2. The controller of claim 1, the device manager being further operable to create a lookup table for the single logical volume.

3. The controller of claim 2, the device manager being further operable to map the logical block addresses of the single logical volume to the one or more individual storage devices.

4. The controller of claim 2, the device manager being further operable to store the lookup table and report the single logical volume to a driver on a host system.

5. The controller of claim 4, the device manager being further operable to send the lookup table to a host system and enable a fast path interface.

6. The controller of claim 1, the device manager being further operable to receive an input/output process request for the single logical volume and perform the input/output process on the one or more individual storage devices.

7. The controller of claim 1, wherein the single logical volume is used as a swap space for an operating system.

8. A method, comprising:
identifying a capacity representing the highest common storage capacity among individual storage devices belonging to a group of storage devices, wherein the individual storage devices have varying levels of individual storage capacity;
allocating space in each of the individual storage devices in the amount of the highest common storage capacity as a Redundant Array of Independent Disks volume; and
generating a single logical volume out of the unallocated space located in one or more of the individual storage devices.

9. The method of claim 8, further comprising:
creating a lookup table for the single logical volume.

10. The method of claim 9, further comprising:
mapping the logical block addresses of the single logical volume to the one or more individual storage devices.

11. The method of claim 9, further comprising:
storing the lookup table and reporting the single logical volume to a driver on a host system.

12. The method of claim 11, further comprising:
sending the lookup table to a host system and enabling a fast path interface.

13. The method of claim 8, further comprising:
receiving an input/output process request for the single logical volume and performing the input/output process on the one or more individual storage devices.

14. The method of claim 8, wherein the single logical volume is used as a swap space for an operating system.

15. A non-transitory computer readable medium embodying programmed instructions which, when executed by a processor, are operable to perform the steps of:
identifying a capacity representing the highest common storage capacity among individual storage devices belonging to a group of storage devices, wherein the individual storage devices have varying levels of individual storage capacity;
allocating space in each of the individual storage devices in the amount of the highest common storage capacity as a Redundant Array of Independent Disks volume; and
generating a single logical volume out of the unallocated space located in one or more of the individual storage devices.

16. The medium of claim 15, the method further comprising:
creating a lookup table for the single logical volume.

17. The medium of claim 16, the method further comprising:
mapping the logical block addresses of the single logical volume to the one or more individual storage devices.

18. The medium of claim 16, the method further comprising:
storing the lookup table and reporting the single logical volume to a volume on a host system.

19. The medium of claim 15, the method further comprising:
receiving an input/output process request for the single logical volume and performing the input/output process on the one or more individual storage devices.

20. The medium of claim 15, wherein the single logical volume is used as a swap space for an operating system.
